(19) United States
(12) Patent Application Publication
(10) Pub. No.: US 2011/0146226 A1
(43) Pub. Date: Jun. 23, 2011

(54) RECUPERATOR FOR GAS TURBINE ENGINES

(75) Inventor: RYAN S. WOOD, Broomfield, CO (US)

(73) Assignee: FRONTLINE AEROSPACE, INC., BROOMFIELD, CO (US)

(21) Appl. No.: 12/650,857

(22) Filed: Dec. 31, 2009

Related U.S. Application Data
(60) Provisional application No. 61/141,878, filed on Dec. 31, 2008.

(51) Int. Cl. F02C 7/10

(52) U.S. Cl. 60/39.511

(57) ABSTRACT

A recuperator for use in transferring heat from gas turbine exhaust gases to compressed air inlet gases before combustion. The recuperator utilizes a plurality of stacked foils that define microchannels to form a recuperator having high effectiveness and low pressure drop while maintaining a low weight. Accordingly, the recuperator presented herein may be incorporated into light aircraft and helicopters without significantly compromising the performance thereof.

### CROSS-REFERENCE TO RELATED APPLICATION

This application claims priority and the benefit of the filing date under 35 U.S.C. 119 to U.S. Provisional Application No. 61/141,878, entitled, “RECUPERATOR FOR AIRCRAFT TURBINE ENGINES,” filed on Dec. 31, 2008, the contents of which are incorporated herein as if set forth in full.

### FIELD

The present disclosure is directed generally to recuperators for use with gas turbine engines. One aspect of the present disclosure is directed to a lightweight microchannel recuperator that has particular applicability for use with gas turbine engines of light aircraft and helicopters.

### BACKGROUND

A gas turbine engine extracts energy from a flow of hot gas produced by combustion of gas or fuel oil in a stream of compressed air. In its simplest form, a gas turbine engine has an air compressor (radial or axial flow) fluidly coupled to a turbine with a combustion chamber disposed therebetween. Energy is released and work is performed when compressed air is mixed with fuel and ignited in the combustor, directed over the turbine's blades, spinning the turbine. Energy is extracted in the form of shaft power (e.g., turboshaft engines) and/or compressed air and thrust (e.g., turbojet/turbofan engines).

Irrespective of the exact engine type, most gas turbine engines operate in a similar manner. Initially, ambient air is received at the inlet of the compressor where it is compressed and discharged at a substantially higher pressure and temperature. The compressed air then passes through the combustion chamber, where it is mixed with fuel and burned thereby further increasing the temperature and, by confining the volume, the resultant pressure for combustion gases. The hot combustion gases are then passed through the hot turbine section where mechanical shaft power may be extracted to drive a shaft, propeller or fan. Any remaining exhaust gas pressure above ambient pressure can be used to provide thrust if exhausted in rearward direction.

Some turbine engines also try to recover heat from the exhaust, which otherwise is wasted energy. For instance, a recuperator is often used in association with the combustion portion of a gas turbine engine, to increase its overall efficiency. Specifically, the recuperator is a heat exchanger that transfers some of the waste heat in the exhaust to the compressed air, thus preheating it before entering the fuel combustor stage. Since the compressed air has been pre-heated, less fuel is needed to heat the compressed air/fuel mixture up to the turbine inlet temperature. By recovering some of the energy usually lost as waste heat, the recuperator can make a gas turbine significantly more efficient.

Use of a recuperator, while improving efficiency of a gas turbine engine, can also have a number of disadvantages in various applications. One such potential disadvantage is the reduction of power of a turbine engine that includes a recuperator. As may be appreciated, passing compressed air from the compressor through plumbing associated with a recuperator/heat exchanger results in a pressure drop of the compressed air thereby reducing the high-end performance (e.g., maximum power) of the engine. Such reduced power output is especially disadvantageous in aircraft and helicopter applications where maximum power is often desired and/or necessary during takeoff or hot and high altitude flying.

Another potential disadvantage is the increased weight of a turbine engine incorporating a recuperator. Such a disadvantage is also evident in aircraft applications where turbine engines are often utilized due to their high power to weight ratio. That is, in most cases, gas turbine engines are considerably smaller and lighter than reciprocating engines of the same power rating. For this reason, turboshaft engines are used to power almost all modern helicopters. Typically, incorporation of a recuperator has heretofore resulted in significant addition of weight to the turbine engine. Historically, the added weight and cost of the recuperator and associated system plumbing has more than offset any reduced fuel consumption, yielding endurance break-even times that are much too long for typical flight times.

For at least these reasons, use of recuperators have not found widespread acceptance in the light aircraft and helicopter industry.

### SUMMARY

Presented herein is a recuperator that may be utilized with turbine engines of light aircraft, such as a helicopter while providing improved fuel consumption and increased endurance of such aircraft with minimal losses in the overall power. The recuperator utilizes a microchannel core that allows for producing a highly efficient recuperator with an overall mass that is low enough to overcome the drawbacks of previous recuperators for aircraft applications.

According to a first aspect, a recuperated gas turbine engine system is provided. Typically, the gas turbine engine will have a compressor, a combustor and a turbine. In one arrangement, the gas turbine engine is an external flow engine where the turbine is disposed between the compressor and the turbine such that an external compressor duct connects the compressor and combustor. In another arrangement, the engine is an axial flow gas turbine engine where the compressor is disposed next to the combustor. In such arrangements, it will be appreciated that the compressed air may have to be diverted out of the compressor, through a recuperator and back into the combustor. In any arrangement, a recuperator is disposed within an exhaust duct of the engine such that exhaust gases may pass over the recuperator. The recuperator is also interconnected to a compressor outlet duct and a combustor inlet duct at the engine. That is, an inlet header of the recuperator is connected to a compressor outlet duct of the engine, and an outlet header is connected to a combustor inlet duct at the engine. A core fluidly interconnects the inlet header and outlet header of the recuperator. In the present arrangement, the core is a microchannel core formed of a plurality of stacked foil layers.

The stacks of metal foils will each have a thickness of between about 7 mils and about 20 mils. The foils are stacked and bonded together. Such bonding may be via diffusion bonding, welding or other bonding mechanisms. In any arrangement, the stack may include alternating compressor foils and exhaust foils. The compressor foils may each include a substantially planar bottom surface and a recessed top surface that extends between first and second lateral sidewalls. This recessed top surface in conjunction with the lateral sidewalls defines a compressor foil inlet and a compressor foil outlet and collectively defines a channel or compressed air flow path across each compressor foil. Likewise, the exhaust foil includes a planar bottom surface and a recessed top surface that extends between first and second lateral sidewalls to define an exhaust gas flow path across the exhaust foil. Typically, the flow paths of the compressor foil and exhaust foils are at least partially transverse. In one arrangement, they are oriented nearly at right angles. In another arrangement, they are counter-flow (e.g., 180 degrees). Other orientations are possible as well.

The recessed top surface of each of the foils may include a plurality of pin'fins that are integrally formed on the recessed top surface. In such an arrangement, the sidewalls and the pin fins may extend above the recessed surface. The pin fins may allow for improving heat transfer between stacked foil layers. In one arrangement, the height of the pin fins is substantially equal to the height of the lateral sidewalls. In such an arrangement, the top surfaces of the pin fins may contact the bottom surface of an overlying foil.

In a further arrangement, some or all of the fin pins may include one or more wings or vortex generators. Such vortex generators are additional protrusions that are spaced laterally from the pin fins. This lateral spacing allows for creating additional turbulence in fluid flowing through the flow paths. In one arrangement, these vortex generators have a height that is substantially the same height as the pin fins. In another arrangement, the vortex generators have a height that is less than the height of the pin fins.

In one arrangement, the pin fins are formed of substantially circular pins. In another arrangement, the pin fins are ovular and/or teardrop-shaped. Likewise, the size and orientation of the vortex generators may vary. In one arrangement, the vortex generators are rectangular structures. In another arrangement, they are triangular structures. In a yet further arrangement, the vortex generators may be formed as teardrops. It will be appreciated that the spacing, size and location of the pin fins and/or vortex generators may be varied. Typically, the pin fins are disposed on the recessed surfaces of the foils in a repeating geometric pattern.

In one arrangement, the recuperator core includes at least 300 compressor foils and at least 300 exhaust foils. In such an arrangement, the total flow path through the compressor foils and the exhaust foils may be sized to accommodate a mass flow of between 1.8 lbs/second and about 4 lbs/second with less than about a 5% pressure drop across the core. In a further arrangement, the pressure drop is less than about 3%.

In one arrangement, the compressor flow paths through the compressor foils are at least three times as long as the overlying and/or underlying exhaust flow paths. In a further arrangement, the compressor flow paths are at least five times the lengths of the exhaust flow paths, and in a yet further arrangement, they are at least 10 times the length of the exhaust flow paths. In such arrangements, the open area through the exhaust foils may be between about three to ten times the area through the compressor foils. This is beneficial as the exhaust gases are typically at a lower pressure than the compressor gases. In one arrangement, the compressor foils and exhaust foils are stacked in an annular configuration. As utilized herein, annular represents a closed geometric pattern (e.g., square, ovular, etc.) and not necessarily circular. In such an arrangement, the center of an inner annular stack of foils may define an exhaust duct. In a further arrangement, the foils are stacked in at least first and second concentric annular configurations. In such an arrangement, space between the first and second annular sets of stacked foils may define one or more inlet exhaust ducts. From these exhaust ducts disposed between the annular sets of foils, exhaust gases may pass out the outer set of exhaust foils and through the inner set of exhaust foils to an interior annulus.

In another aspect, a method is provided for retrofitting a recuperator onto a gas turbine engine including an external compressor outlet duct extending between a compressor and a combustor inlet. The method includes providing a cross or counter-flow recuperator having an inlet header and an outlet header and a stacked foil core having a plurality of compressed air and exhaust gas microchannels. The recuperator further includes an exhaust inlet port and an exhaust outlet port. The method further includes replacing the external duct extending between the compressor outlet and the combustor inlet with a first duct extending between the compressor outlet and the inlet header of the recuperator. A second duct is extended between the outlet header and the combustor inlet. Furthermore, the recuperator is disposed into an exhaust path of the engine such that exhaust gases enter into the exhaust inlet port of the recuperator and exit from the exhaust outlet port of the recuperator after passing through the exhaust gas microchannels. The method may further include providing bypass ducts for the compressed gas inlet and/or exhaust gases.

### BRIEF DESCRIPTION OF THE DRAWINGS

FIG. 1 illustrates a perspective view of a gas turbine engine.

FIG. 2 shows a side view of the engine of FIG. 1.

FIG. 3 shows an end view of the engine of FIG. 1.

FIG. 4 shows a side view of the engine of FIG. 1 with a recuperator.

FIG. 5 shows an end view of the engine of FIG. 1 with a recuperator.

FIG. 6 shows a top view of the engine of FIG. 1 with a recuperator.

FIG. 7 shows a perspective view of a recuperator.

FIG. 8 shows a perspective view of a core of a recuperator.

FIG. 9A shows a perspective view of one-half of a compressor foil layer of the recuperator of FIG. 8.

FIG. 9B shows a perspective view of one-half of an exhaust foil layer of the recuperator of FIG. 8.

FIG. 10A illustrates an exploded view of a compressor foil and an exhaust foil.

FIG. 10B illustrates the compressor foil and exhaust foil of FIG. 10A as stacked.

FIG. 11 is a cross-sectional view of the recuperator of FIG. 8 illustrating exhaust gas flow through the recuperator.

FIGS. 12A-12C illustrates pin fin arrangement that may be utilized with the compressor and exhaust foils.

FIGS. 13A-13C illustrates pin fin arrangement that may be utilized with the compressor and exhaust foils.

### DETAILED DESCRIPTION

Reference will now be made to the accompanying drawings, which assist in illustrating the various pertinent features of the various novel aspects of the present disclosure. Although the invention is described primarily with respect to a recuperator embodiment for use with a specific turbine engine family, the invention is applicable to a broad range of turbine engines outside of this engine family. In this regard, the following description is presented for purposes of illustration and description. Furthermore, the description is not intended to limit the invention to the form disclosed herein. Consequently, variations and modifications commensurate with the following teachings, and skill and knowledge of the relevant art, are within the scope of the present invention.

As noted, the recuperator discussed herein may be utilized with a variety of different gas turbine engines, however, it is especially well suited for use in the Rolls-Royce Model 250 family of engines (US military designation T63). This family of engines has a number of different sizes and varying configurations. The engine was originally designed by a General Motors offshoot, the Allison Engine Company, in the early 60's. A program of continuous development has resulted in a range of engine models that power many of the world's most popular small aircraft and helicopters. For instance, a small non-inclusive list includes the Bell 206B/TH-67, MDH MD500/520N and Eurocopter AS.355/BO 105. As a result, nearly 30,000 Model 250 engines have been produced. Of these, approximately 17,000 remain in active service.

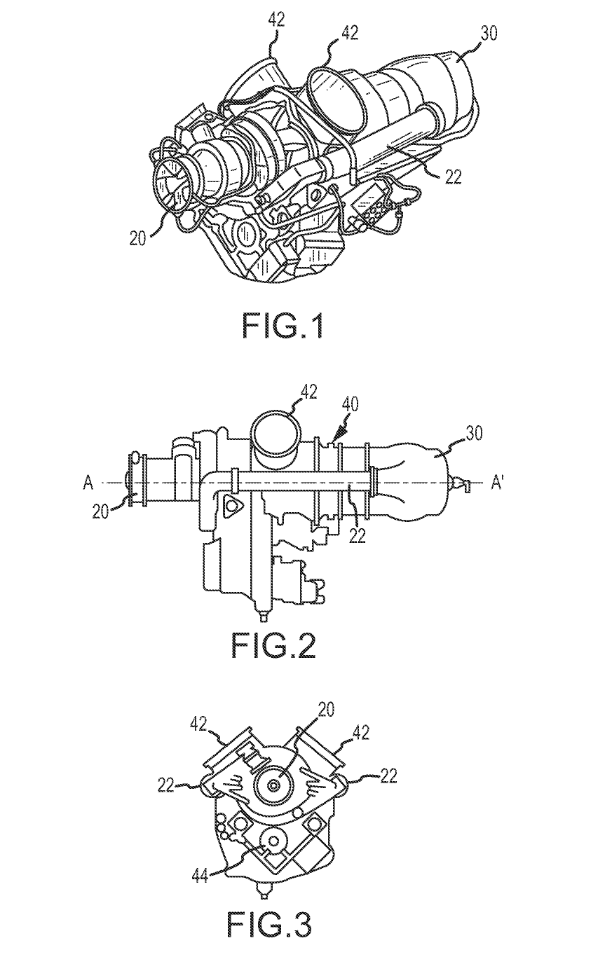

The Model 250 engine 10, as schematically shown in the perspective, side and front views of FIGS. 1-3, utilize what is sometimes referred to as a “trombone” engine configuration where air enters the intake of the compressor 20 in a conventional fashion but compressed air leaving the compressor 20 is ducted rearwards around the turbine system via external air ducts 22. That is, unlike most other turboshaft engines, the compressor 20, combustor 30 and turbine stage 40 are not provided in an inline configuration, with the compressor at the front and the turbine at the rear where compressed air flows axially through the engine. Rather, in the Model 250 engines, the engine air from the forward compressor 20 is channeled through the external compressed air ducts 22 on each side of the engine 10 to the combustor 30 located at the rear of the engine. The exhaust gases from the combustor 30 then pass into a turbine stage 40 located intermediate the combustor 30 and the compressor 20. The exhaust gases are exhausted mid-engine in a radial direction from the turbine axis A-A of the engine, through two exhaust ducts 42. A power take-off shaft 44 connects the power turbine of the turbine stage to a compact reduction gearbox (not shown) located inboard between the compressor and the exhaust/power turbine system.

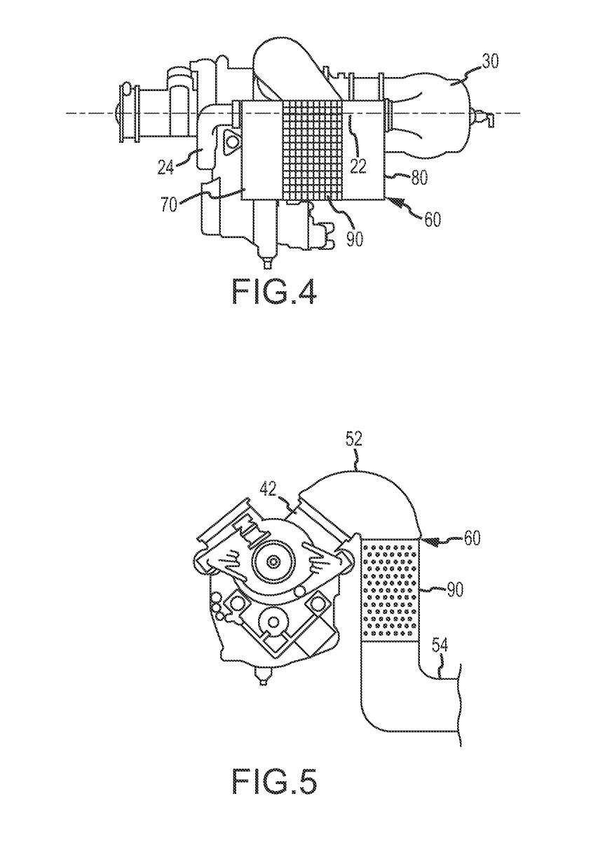

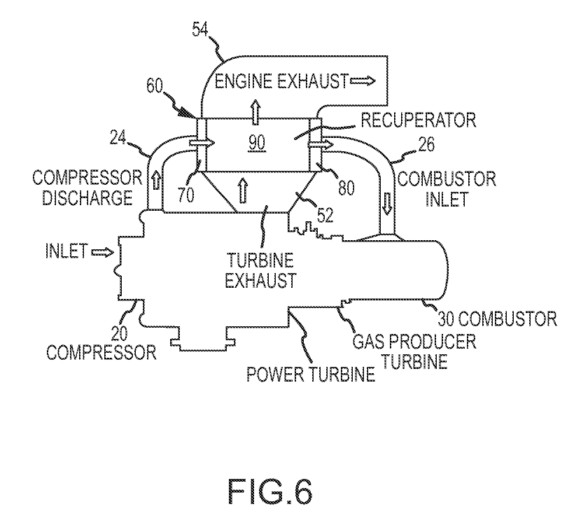

As shown in FIGS. 4-6, the compressed air ducts 22 can be readily tapped, replaced and/or rerouted through a recuperator 60 that is incorporated into ducting 52, 54 connected to the exhaust duct 42 and leading to an exhaust outlet (not shown). Once rerouted, air is drawn into the compressor 20, where it is compressed and then discharged through a pair (only one shown) of compressor outlet ducts 24 extending between the compressor outlets and the recuperator inlet header 70. The inlet header feeds the compressed air into and through the core 90 of the recuperator 60 where the compressed air is heated by the exhaust gases. The heated compressed air then passes from the recuperator core 90 into an outlet header 80 and then into the combustor 30. In some embodiments, manifolds or combustor inlet ducts 26 may extend between the outlet of the outlet header 80 and the inlet of the combustor 30. In any case, the hot combustion gases from the combustor 30 are then passed to the turbine stages. It is thus clearly seen that the Model 250 engine can be readily modified by replacing the external compressor air discharge ducts 20 with appropriate manifold/ducting without unduly changing the air flow path of the system.

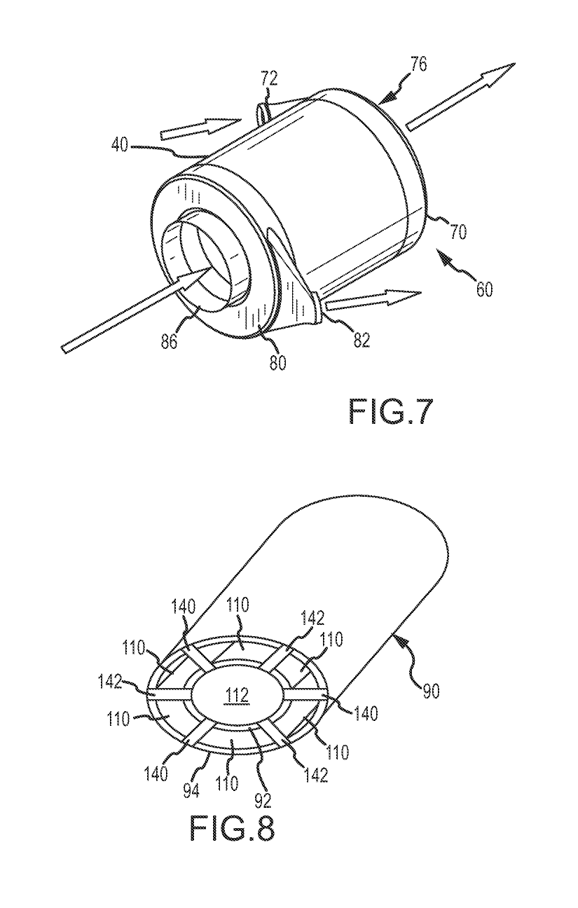

As shown in FIG. 7, the recuperator 60 includes an inlet header 70, an outlet header 80 and a housing 40 that extends between the inlet header 70 and the outlet header 80. In various arrangements, the housing 40 may form a portion of the exhaust ducting of the engine. As shown, compressed airflow from the compressor enters into an inlet 72 of the inlet header 70. This compressed airflow is received within an interior volume of the header from where it passes through the core of the recuperator, which is formed of a plurality of stacked foils that define microchannels as will be further discussed herein. The compressed air then passes into an interior volume of the outlet header 80 and through an outlet 82 of the outlet header 80. In conjunction with such compressed airflow, exhaust gases enter into exhaust port 86 pass through exhaust gas flow channels in the core and exit through an exhaust port 76 (not shown). The exhaust ports 76, 86 may be incorporated into exhaust gas ducting of the engine. Other configurations are possible as well and are considered within the scope of the present disclosure. In any arrangement, the core is designed such that the compressed airflow and exhaust gases counter-flow or cross-flow through the recuperator 60 to transfer heat from the exhaust gases to the compressed airflow.

While this family of turbine engines, as well as other turbine engines, may be retrofit to utilize a recuperator, use of recuperators has not found widespread acceptance in the aircraft industry. One of the main reasons for the reluctance to utilize such recuperators is the increase in the weight of the engine system that is realized through the incorporation of the recuperator. For instance, while a recuperator may reduce fuel consumption of a gas turbine engine by raising the thermal efficiency of the engine, for example, from around 20% to around 30%, such fuel savings often do not offset the added weight incurred by incorporating a recuperator into an aircraft power system. That is, if fuel weighs 6 pounds per gallon and a recuperator system increased the weight of the engine by 140 pounds, fuel savings would have to be over 23 gallons to offset the added weight of the recuperator system without reducing the range of the aircraft. In this regard, the trade-off in fuel savings has not been great enough to offset the compromise to performance (e.g., maximum range, etc.) of aircraft incorporating such existing recuperators. This is due in part to the previous construction of most recuperators that utilize a plate-fin heat exchanger arrangement. Typically, such plate-fin arrangements results in recuperators of considerable mass and volume. Additionally, such plate-fin heat exchangers/recuperators have also resulted in considerable pressure drop of the compressed fluid moving across the recuperators. In this regard, previous recuperators have resulted in significant pressure drops, which significantly reduce the maximum power of a turbine engine. As will be appreciated, during aircraft operations, and especially take-off operations, aircraft often require maximum power. By incorporating a recuperator that significantly reduces the maximum power by imposing significant pressure drops, previous recuperators have provided an additional reason for limiting their use in light aircraft operations.

The recuperator of the present invention overcomes these difficulties by utilizing a novel light-weight approach that provides high efficiency heat transfer between compressed gases and exhaust gases with minimal pressure drop. The recuperator of the present invention may, in some embodiments, be installed with Model 250 engines where the installed system (including necessary ducting) weighs less than about 40% of the engine height. In any gas turbine engine system utilized for aircraft, it may be desirable that the total weight of a recuperator system may be less than about 40% of the weight of the engine.

FIG. 8 illustrates one embodiment of a core section 90 of the recuperator 60. In this particular arrangement, the recuperator core 90 is formed of concentric sets 92, 94 of stacked foils. The core 90 is formed using a plurality of laminated/bonded foils that define a plurality of small dimension microchannels channels. In such an arrangement, alternating layers of foils define compressed air channels and exhaust gas channels. That is, a first set of compressor foils define channels or flow paths that carry compressed airflow between the inlet and outlet headers of the recuperator (not shown) and a second set of exhaust foils define channels or flow paths that carry exhaust gases across (e.g., counter) the compressed air channels.

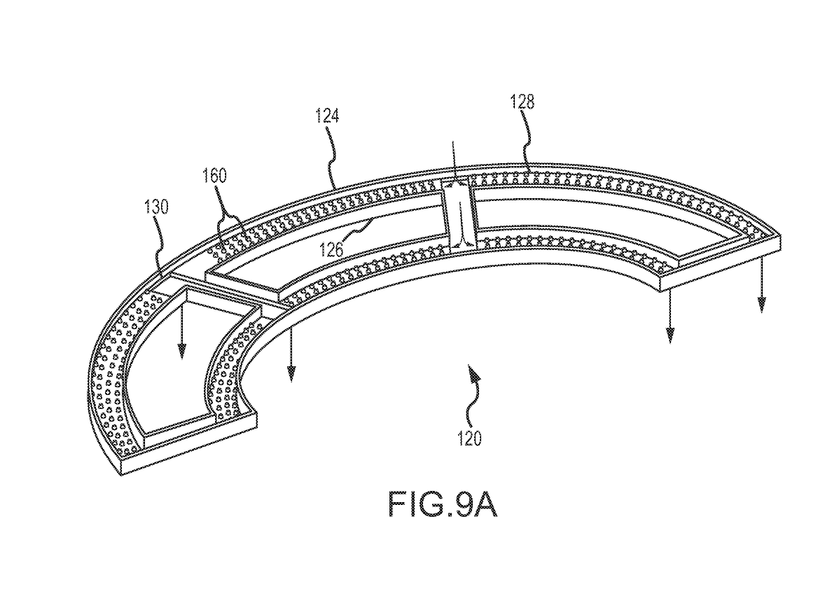

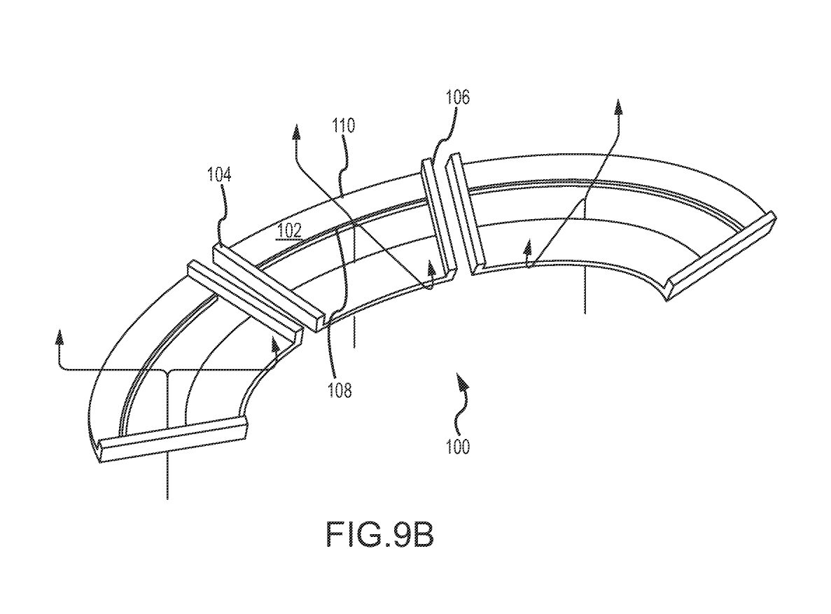

The core is formed by stacking and bonding the compressor foils and exhaust foils on top of one another. See, e.g., FIGS. 9A-B and 10A-B. FIGS. 9A and 9B illustrate one-half of a single layer of compressor foils 120 (FIG. 9A) and exhaust foils (FIG. 9B). As shown, the compressor foil of FIG. 9A includes a plurality of pin fins 160 (not to scale) and the exhaust foil of FIG. 9B is free of such pin fins. In practice, both foils 100, 120 will typically have pin fins. FIG. 9B is illustrated without pin fins for purposes of clarity.

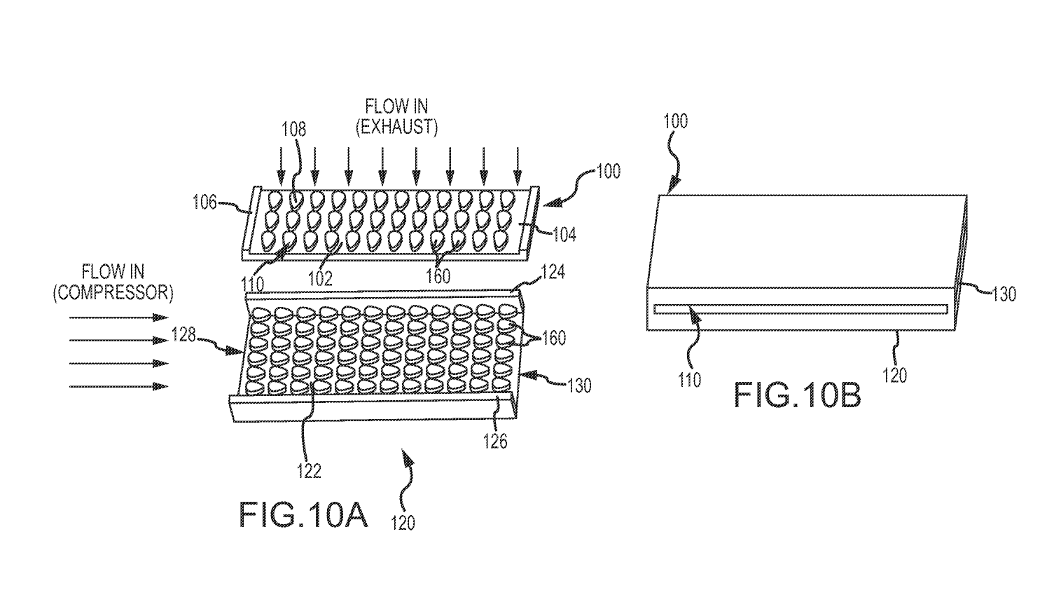

FIGS. 10A and 10B provide a simplified illustration of stacked foil layers, though the discussion in relation to these Figures is applicable to the foils of FIGS. 9A and 9B. As shown, flow paths through successive foil layers 110, 120 are rotated with respect to one another to form a cross-flow configuration. However, it will be appreciated that in other embodiments a counter-flow configuration may be utilized as well. Generally, each foil is contoured such that, when bonded/laminated to an overlying and/or underlying foil, one or more fluid flow channels are formed between the bonded/laminated foils. The foils are typically formed of stainless steels, nickel alloys, titanium alloys, aluminum and/or aluminum alloys. However, use of other materials is possible and is considered within the scope of the present disclosure.

Typically, the core is formed by stacking the foil layers in a desired configuration and diffusion bonding or welding the layers to form hermetically sealed sets of compressed air and exhaust gas microchannels. In one arrangement, 355 compressor foils and 355 exhaust foils form the core. The foils may be made in any manner that allows forming a channel in the foil. For instance, the individual foils may be milled. However, in the present arrangement, the foils are made using a chemical etching process. In this process, the top surfaces of blank foils are masked (e.g., to define sidewalls, pin fins, etc.) and the unmasked surface is chemically etched.

FIGS. 10A and 10B illustrate exploded and assembled views, respectively, of simplified first and second foils that make a single compressed air flow path. Foils utilized to form the core (see, e.g., FIGS. 9A, 9B) utilize similar features. As shown, an exhaust foil 100 is disposed on top of a compressor foil 120. See FIG. 10B. As shown, each of the foils 100, 120 is a thin metal sheet that has a substantially planar bottom surface and a recessed top surface 102, 122, respectively. For example, the compressor foil 120 has a recessed top surface 122 that extends between first and second lateral sidewalls 124, 126. Generally, these lateral sidewalls 124, 126 extend the length of the foil 120 and define a channel between an inlet end 128 and an outlet end 130 of the foil. Generally, the height of the lateral sidewalls 126, 124 is equal to the original thickness of the foil. Similarly to the compressor foil 120, the exhaust foil 100 has first and second lateral sidewalls 104, 106 and a recessed surface 102. Again, the lateral sidewalls 104, 106 and the recessed top surface 102 define a channel between an exhaust gas inlet 108 and an exhaust gas outlet 110. When these foils 100, 102 are laminated together, the bottom surface of an overlying foil (e.g., 100) and the recessed top surface 122 and sidewalls 124, 126 of an underlying foil (e.g., 120) define a compressed air flow channel. Likewise, by overlying another compressor foil or a blank foil sheet over the top of the exhaust foil of FIG. 8B, an exhaust gas flow channel may be formed.

The thickness of the foils (e.g., compressor foils and/or exhaust foils) generally ranges from about 7 mils to about 20 mils (e.g., from about 0.178 mm to about 0.51 mm). Generally, the bottom of the recessed top surface 102, 122 will have a depth (e.g., measured from the top of the sidewalls) that is significantly less than the height of the first and second lateral sidewalls. For instance, where the lateral sidewalls are 7 mils in height, the recess may be 5 mils in depth. Generally, the distance between the bottom of the recessed surface and bottom of the foil will be at least about 2 mils. It will be appreciated that reducing the thickness between the surfaces increases heat transfer between the exhaust gases and the compressed air. However, it will be appreciated that other arrangements may be utilized and are considered within the scope of the present invention.

When the foils have a thickness between about 7 mils and about 20 mils, the flow paths or channels formed in the foils will have a height between about 5 mils and about 18 mils. The width and length of the channels may vary. For instance, in the present arrangement, the width of the compressed air channel (e.g., compressed air flow path) through a pair of laminated foils is typically between about 0.25 inches and about 1.0 inches whereas the length between a foil inlet and outlet may be between about 1 inch and about 10 inches. The exhaust gas flow path may have a width that is equal to the length of the compressed air flow path and a length that is equal to the width of the compressed air flow path. For instance, in one arrangement, the compressed air flow path has a width between lateral sidewalls of approximately 0.4 inches and a length of approximately 4 inches. In this orientation, the exhaust gas foil 100 has a width of approximately 4 inches and the length of approximately 0.4 inches. That is, the length of the compressed air flow path is greater than the length of the exhaust gas flow path. This is beneficial as the exhaust gases are near ambient pressure levels (i.e., low pressure) and it is desirable that the exhaust gas flow channels be short to reduce pressure losses. In contrast, air from the compressor is at a relatively high pressure (e.g., 100 psi or greater), which allows the compressed air to flow through a longer flow channel with minimal pressure loss. Further, the use of a long compressed air flow path and a shorter, wider cross-flow exhaust gas flow path allows for conducting greater amounts of heat to the compressed air. That is, the compressed air is repeatedly exposed to high temperature exhaust gas while traveling over the length of the compressed air flow path.

In any case, use of these small dimension channels (e.g., microchannels) increase surface area through the recuperator, which improves heat exchange between the working fluids. That is, as a hydraulic diameter of a fluid channel decreases, a convection heat transfer coefficient increases as does the surface to area volume ratio. Stated otherwise, by constraining the flow through such microchannels, thermal diffusion lengths are short and the heat transfer coefficients are very high.

While increased pressure gradients are often associated with flow through such small microchannels, the presented cores utilize short flow paths to reduce the pressure drop across the core. That is, while the pressure gradient within the microchannels is typically high, the short length of those microchannels and large number of channels allows a high mass flow rate through the heat exchanger with a low overall pressure drop. Further, as the presented designs provide a shorter cross-flow path for the low pressure exhaust gases and a longer flow path for the high pressure compressed air, this cross-flow microchannel design allows for much higher ratios of heat transfer from the exhaust gases to the compressed gases than has previously been attained.

Referring again to FIG. 8, the core as illustrated includes three compressed air inlets 140 and three compressed air outlets 142. In operation, compressed air from the compressor is introduced into the compressed air inlets 140 via an inlet header (not shown) that is interconnected to the compressor via the compressor outlet duct. Compressed air flows into these inlets and then along the microchannels in the foils formed by the lateral sidewalls of each foil and the bottom surface of the overlying exhaust foils. See, e.g., FIG. 9A. The compressed air passes, in parallel, through all the channels of all the stacked foils (e.g., 300-400 compressor foils) until the air reaches the compressed gas outlets 142, which is fluidly connected to the outlet header (not shown), to provide pre-heated compressed air to the combustor.

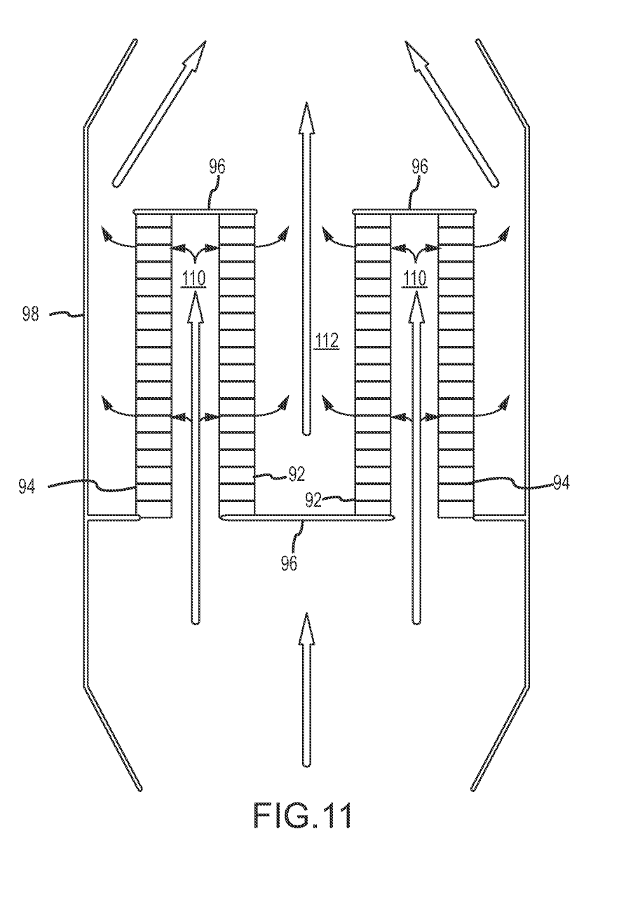

The exhaust gases enter the core 90 through six outer exhaust ducts 110 disposed between the concentric sets 92, 94 of stacked foils. The exhaust gases then spread outwardly through the first and second concentric sets of foils. See, e.g., FIGS. 9B and 11. In the embodiment shown in FIG. 11, the exhaust gases enter into the exhaust gas ducts 110 and are prevented from exiting the core by an end plate 96 that covers an outlet end of exhaust ducts 110 and/or end plate 96 covers an inlet end of a central exhaust duct. These end plates route the exhaust gases into the outer exhaust ducts after which the gases expand outwardly and pass through the outer set of stacked foils 94 and the inner set of stacked foils 92. The gases that pass through the outer set of stacked foils 94 are captured by exhaust ducting 98 surrounding the core. The exhaust gases that pass inwardly through the inner set of stacked foils 92 pass into the central annular exhaust duct 112 and are routed into an exhaust duct of the engine. This is illustrated in FIG. 11, which is a cross-sectional view of FIG. 8. As will be appreciated, the compressed gas inlets and outlets 140, 142 are fluidly isolated from the exhaust ducts 110, 112. That is, the walls of the gas inlets and outlets are solid and prevent fluid transfer between these compressed gas ducts and the exhaust ducts.

To further improve the heat transfer between the exhaust gas microchannels and the compressed air microchannels, various embodiments of the presented microchannel recuperators utilize pin fins within the flow paths. That is, the recessed top surfaces of one of or both of the exhaust foils 100 and compressor foils 120 include a plurality of pin fins 160. See, FIGS. 10A-B. Typically, these pin fins 160 are disposed on the top recessed surfaces of the foils in a repeating geometric pattern. The size, spacing and shape of these pin fins 160 may be selected based on flow rates and/or gas/air flow pressures associated with a particular engine, maximum allowable pressure drops through flow channels and/or other variables. However, it will be appreciated that various embodiments of the microchannel recuperator may be formed without such pin fins.

The pin fins 160 provide an obstruction in the flow paths of the compressed air and/or the exhaust gases through their respective channels. These pin fins 160 enhance heat transfer by creating turbulent flow through the flow channels. Further, in one arrangement these pin fins have a height that is substantially equal to the height of the lateral side walls of their respective foils 100 or 120. In this regard, when the foils are bonded together, the top of most or all of the pin fins 160 contact the planar bottom surface of the overlying foil.

Contact between the pin fins 160 and overlying foils also improves the conductive heat transfer between the foils. That is, this contact allows for conducting heat from or to the overlying foil. Further, the pin fins 160 themselves increase the surface area of the flow channels. This increased surface area likewise increases the amount of heat may be transferred from the exhaust gases to the compressed air. However, the pin fins 160 can increase the pressure drop through the flow channels as their structure blocks a portion of the cross-sectional opening of the flow channel. Accordingly, a balance must be struck between the increased heat transfer and the increased pressure drop. That is, the number location and/or size of the pin fins may be varied to improve heat transfer without causing excessive pressure drops.

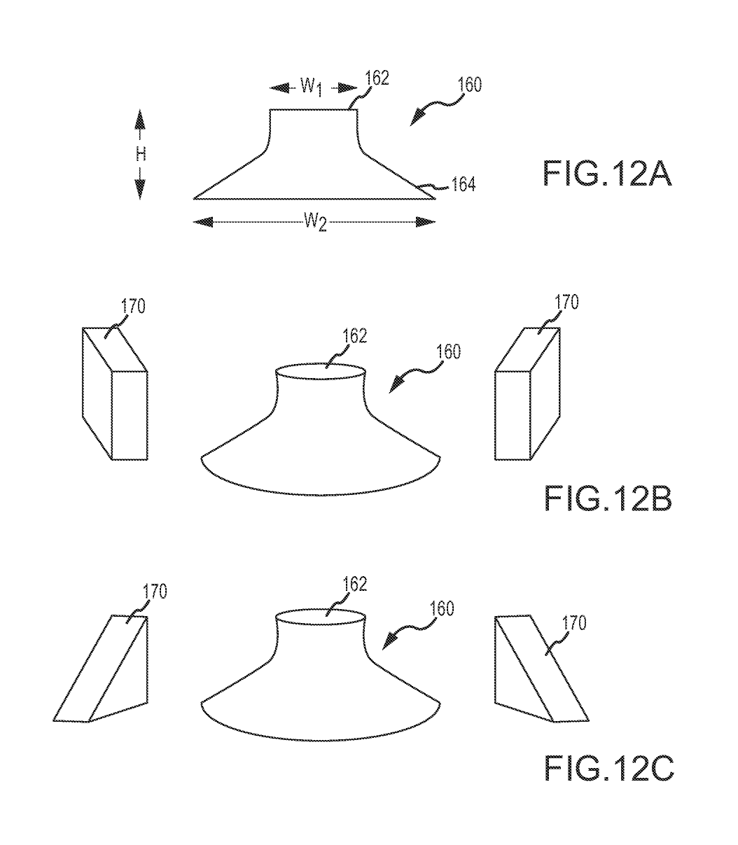

FIG. 12A illustrates a cross sectional view of one embodiment of a pin fin that may be formed on the recessed surface of the exhaust foil 100 and/or the compressor foil 120. In the illustrated embodiment, the top surface 162 of the pin fin 160 is substantially circular and extends downward as a column towards its base. In various arrangements, these pin fins may be formed as cylindrical columns from top to bottom. However, in the present embodiment the lower portion of the pin fin has a tapered base section 164 with a diameter that is larger than the diameter of the top surface. Use of the larger diameter base allows for creating turbulent flow over a greater area of the recessed surface of the flow channel without directly blocking cross sectional area through the flow channel. Additionally, when the recessed surfaces and pin fins of the foils 100, 120 are formed in a chemical masking/etching process the pin fins may take on a more trapezoidal cross-section shape. Of further note, generation of the pin fins in masking/etching process may result in some of the fins having a height that is less than the original thickness of the foil. As may be appreciated, pins with such a reduced height may not contact the overlying foil layer upon assembly.

It will be appreciated that the shape of the pin fin may be varied. For instance, ovular and/or teardrop shaped pin fins may be advantageously utilized. In such arrangements, the long axis of such pin fins may be aligned with the direction of fluid flow through the fluid channel and thereby provide increased contact between the foil layers without increasing the obstructed cross-sectional area through the flow channel.

To further increase turbulent flow in the flow channels and/or to reduce the cross-sectional area obstructed by the pin fins, various embodiments of the microchannel recuperator also utilize vortex generators in conjunctions with pin fins. A vortex generator is a small obstruction in the flow passage which creates turbulent flow of fluids passing over the generator and thereby increases energy transfer. That is, such vortex generators enhance heat transfer by causing velocity fluctuations that reduce a boundary layer of fluid flowing through the microchannel. The common types of vortex generators are wings/winglets 170 that may be set to the sides and downstream (or potentially upstream) from a pin fin. See FIGS. 12b and 12C. The most common shapes of the wings/winglets are rectangular (see FIG. 12B) and triangular/delta (see FIG. 12C). However, the shape, size, aspect ratio, an angle attack (e.g., disposition relative to fluid flow direction) are among various parameters it may be altered to achieve the desired effectiveness.

It has been determined that use of pin fins without the vortex generators often results in an area of high turbulence (e.g., a vortex) directly behind the pin fin with significantly reduced turbulent fluid flow passing between the rows/files of pin fins. Accordingly, the vortex generators are typically laterally offset and located slightly downstream relative to their respective pin fin. That is, the vortex generators are located slightly behind and to the sides of their pin fin. Fluid passing around the pin fin is directed onto the vortex generator. These vortex generators cause the fluid passing over to further swirl, resulting in increased turbulent flow. It has been found that inclusion of such vortex generators may allow for reducing the number of pin fins by half without affecting heat transfer.

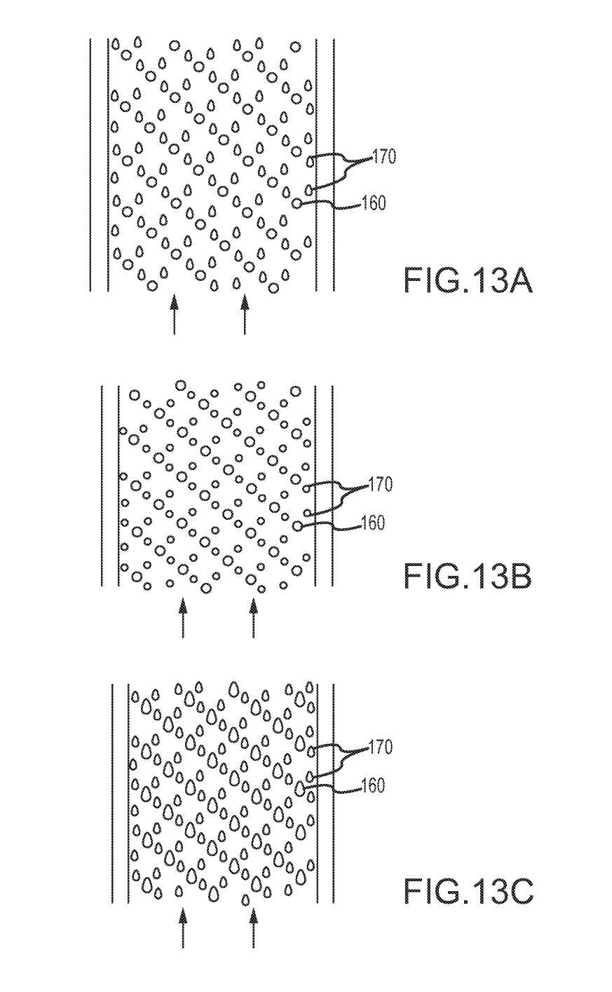

Though illustrated in FIGS. 12A and 12B as utilizing rectangular or triangular vortex generators 170, it will be appreciated that many other sizes and shapes may be utilized. A non-limiting set of such shapes and dispositions of such vortex generators are illustrated in FIGS. 13A-13C. Specifically, FIG. 13A illustrates use of circular pin fins 160 each having with first and second teardrop shaped vortex generators 170 disposed downstream and to either side of each pin fin 160. FIG. 13B illustrates utilizing first and second substantially circular vortex generators with each circular, pin fin 160. FIG. 13C illustrates utilizing teardrop or ovular shaped pin fins 160 with teardrop/ovular shaped vortex generators 170.

Use of the vortex generators may allow for use of fewer pin fins without reducing the heat transfer between the foils and thereby result in a reduced pressure drop through the flow channel. In various embodiments, the vortex generators may extend from the recessed surface and contact the overlying foil layer. However, the vortex generators typically have a much smaller cross-dimension than the pin fins, which reduces the pressure drop through the channel. Further, the vortex generators need not contact the overlying foil and may have a height that is less than the height of the microchannel.

It will be appreciated that the amount of heat transferred to compressed air as it passes through the core between the inlet header and the outlet header is a function of a number of variables. For instance, the length, material type and thickness of the foil layers will affect heat transfer between the compressed air and exhaust gases. Likewise, the flow (e.g., laminar or turbulent flow) of the compressed air flow through the compressed air channels as well as the flow of the exhaust gases through the exhaust gas channels will affect heat transfer there between. That is, the flow through the channels is a function of, among other components, the pressure of the air or gas, mass flow rate, the height and width of the channels, number and/or spacing of pin fins, vortex generators, etc. These various components as well as other components may be adjusted based on the requirements of an individual recuperator system.

In any arrangement, the microchannel core provides a significant increase in surface area in comparison to, for example, a standard plate-fin arrangement while also providing substantial weight reduction. In this regard, use of a microchannel/stacked foil recuperator allows for achieving desired thermal transfer between exhaust gases and compressed airflow to achieve effectiveness ratings that allow for increasing the overall thermal efficiency of an engine without significantly reducing the maximum power of the engine and/or reducing the range/endurance of an aircraft utilizing such a recuperator. That is, utilization of microchannel/stacked foils allows for making a light-weight recuperator where the increased weight of an engine incorporating such a recuperator is offset by the increased efficiency such that the overall endurance of an aircraft incorporating such recuperator may actually be increased while reducing the fuel consumption of the aircraft.

In relation to the effectiveness of the recuperator, it is noted that the effectiveness of a cross-flow or counter-flow heat recuperator is defined by the differential of the exhaust gases (i.e., Ex) across the recuperator divided by the temperature differential of the compressed air (i.e., CA) across the recuperator. Specifically:

$$Effectiveness = \frac{( {TEx}_{i n} - {TEx}_{out} )}{( {TCA}_{out} - {TCA}_{i n} )} . \qquad Eq . 1$$

Simply stated, the effectiveness is a fraction of the total temperature difference of the flows into the hot side and cold side of the recuperator. When the effectiveness is 1.0, the hot side out temperature of the compressed air would equal the exhaust gas inlet temperature. However, this can never happen as an infinite heat exchange surface would be required. However, while a 1.0 effectiveness is not achievable, use of the microchannel core allows for achieving 0.6, 0.7, 0.8 or greater effectiveness while maintaining a compact and light weight recuperator. It will be appreciated that by having an effectiveness of over at least 0.6 that engine efficiency may be increased significantly. That is, less fuel is required by the combustor to raise the compressed air to the necessary temperatures to power the turbine.

It will be noted that pressure drop across the recuperator will result in reduced engine power and such pressure drop can significantly affects shaft output power. However, the use of a large number of microchannels having relatively short flow path length allows the recuperator to have an effectiveness of in excess of 0.6 or even 0.8 while maintaining a pressure drop of less than about 3-5%. Accordingly, while this affects the total power output of the system, such reduced power output may be within allowable limits.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A gas turbine engine system having a compressor, a combustor and a turbine disposed, wherein an exhaust duct exits the turbine, the engine system further comprising:
a recuperator at least partially disposed within an exhaust stream of the exhaust duct and including an inlet header fluidly connected to a compressor outlet duct of the engine, an outlet header fluidly connected to a combustor inlet duct of the engine, and a core fluidly connecting the inlet header and outlet header, said core comprising:
a stack of metal foils each having a thickness of less than about 20 mils and being bonded together, said stack including alternating compressor foils and exhaust foils;
said compressor foils including:
a substantially planar bottom surface;
a recessed top surface extending between first and second lateral sidewalls and between a compressor foil inlet and a compressor foil outlet, wherein said recessed surface defines a compressed air flow path across said compressor foil for carrying compressed air from the inlet header to the outlet header;
a plurality of pin fins integrally formed within said recessed top surface, wherein said sidewalls and said pin fins extend above said recessed surface, wherein said lateral sidewalls are bonded to a bottom surface of an overlying foil, said exhaust foils comprising:
a substantially planar bottom surface;
a recessed top surface extending between first and second lateral sidewalls and between an exhaust foil inlet and an exhaust foil outlet, wherein said recessed surface defines an exhaust gas flow path across said exhaust foil, wherein said exhaust gas flow path and said compressed air flow path are at least partially transverse;
a plurality of pin fins integrally formed on said recessed top surface, wherein said sidewalls and said pin fins extend above said recessed surface, wherein the lateral sidewalls are bonded to a bottom surface of an overlying foil.

2. The system of claim 1, wherein top surfaces of said pin fins are bonded to the bottom surface of the overlying foil.

3. The system of claim 1, wherein said recuperator comprises at least three hundred compressor foils and at least three hundred exhaust foils.

4. The system of claim 1, wherein top surfaces of said sidewalls of said foils are substantially co-planar and define a top reference plane for said foils.

5. The system of claim 4, wherein a bottom of said recessed top surface of said compressor foils and said exhaust foils have a depth of between about 5 mils and about 18 mils, wherein said depth defines a height of said inlet openings and said outlet openings.

6. The system of claim 5, wherein a length of said compressor flow path is at least five times a length of the compressor flow path.

7. The system of claim 1, wherein said fin pins are distributed on said recessed surfaces in a repeating geometric pattern

8. The system of claim 7, wherein said pin fins further comprise:
at least one wing disposed to a lateral side of each said pin fin and at least partially downstream of said pin fin.

9. The system of claim 8, wherein at least one said pin fins and said wings have a teardrop shape.

10. A recuperator at least partially disposable within an exhaust stream of a gas turbine engine and having an inlet header fluidly connectable to a compressor outlet duct of a the gas turbine engine and an outlet header fluidly connectable to a combustor inlet duct of the gas turbine engine and a core fluidly connecting the inlet header and outlet header, said core comprising:
a first stack of elongated metal foils that each have a length at least five times their width and each have a thickness of less than about 20 mils, wherein said metal foils are bonded together and said first stack includes alternating compressor foils and exhaust foils;
a second stack of elongated metal foils that each have a length at least five times their width and each have a thickness of less than about 20 mils, wherein said metal foils are bonded together and said second stack includes alternating compressor foils and exhaust foils, wherein first and second stacks are spaced to have facing side surfaces, wherein a space between said stacks defines an exhaust duct;
wherein each said compressor foil includes a compressed air flow channel having inlet on a first end of a respective one of said stacks and an outlet on a second end of a respective one of said stacks;
wherein each said exhaust foil includes an exhaust gas flow channel having an inlet on one of said facing side surfaces of said stacks and an outlet an opposing side surface of a respective one of said stacks, wherein exhaust received within said exhaust duct passes outwardly through said exhaust gas flow channels in said first and second stacks and wherein a combined open area through said exhaust flow channels is at least five times the combined open area through said compressed air flow channels.

11. The recuperator of claim 10, further comprising:
a compressed air inlet port in fluid communication with said inlets of said compressed air flow channels of said first and second stacks; and
a compressed air outlet port in fluid communication with said outlets of said compressed air flow channels of said first and second stacks, wherein portions of said inlet port and said outlet port extend between said first and second stacks and at least partially define said exhaust duct.

12. The recuperator of claim 10, wherein
said compressor and exhaust foils include:
a substantially planar bottom surface;
a recessed top surface extending between first and second lateral sidewalls which extend between the inlet and outlet of the foil, wherein said lateral sidewalls are bonded to a bottom surface of an overlying foil.

13. The recuperator of claim 12, further comprising:
a plurality of pin fins integrally formed within said recessed top surface of said foils, wherein said pin fins extend above said recessed surface.

14. The recuperator of claim 13, wherein top surfaces of said pin fins are bonded to the bottom surface of the overlying foil.

15. The recuperator of claim 13, wherein said fin pins are distributed on said recessed surfaces in a repeating geometric pattern.

16. The system of claim 15, wherein at least a portion of said pin fins further comprise:
at least one wing disposed to a lateral side of said pin fin, wherein said wing is disposed and at least partially downstream of said pin fin.

17. The recuperator of claim 10 wherein said channels in said compressor and exhaust foils have a height of between about 5 mils and about 18 mils.

18. A recuperator at least partially disposable within an exhaust stream of a gas turbine engine and having an inlet header fluidly connectable to a compressor outlet duct of a the gas turbine engine and an outlet header fluidly connectable to a combustor inlet duct of the gas turbine engine and a core fluidly connecting the inlet header and outlet header, said core comprising:
an outer annular stack of metal foils each having a thickness of less than about 20 mils, wherein said metal foils are bonded together and said outer stack includes alternating compressor foils and exhaust foils;
an inner annular stack of metal foils having a thickness of less than about 20 mils, wherein said metal foils are bonded together and said inner stack includes alternating compressor foils and exhaust foils, wherein inner and outer annular stacks substantially concentric and a space between said stacks defines an exhaust inlet duct;
wherein each said compressor foil includes a compressed air flow channel having a maximum height between about 5 mils and about 18 mils that extends around the length of a portion of a respective one of said annular stacks between at least first and second compressed air inlet and outlet ducts;
wherein each said exhaust foil includes an exhaust gas flow channel having a maximum height between about 5 mils and about 18 mils that extends radially across a respective of one of said annular stacks, wherein exhaust gases received by said exhaust inlet duct pass outwardly and inwardly through said exhaust gas flow channels in said outer and inner annular stacks, respectively.

19. The recuperator of claim 18, wherein an interior defined by an inner one of said annular stacks defines an exhaust outlet port.

20. The recuperator of claim 18, wherein
said compressor and exhaust foils include:
a substantially planar bottom surface;
a recessed top surface extending between first and second lateral sidewalls which extend between an inlet and outlet of the foil, wherein said lateral sidewalls are bonded to a bottom surface of an overlying foil; and
a plurality of pin fins integrally formed within said recessed top surface of said foils, wherein said pin fins extend above said recessed surface and wherein at least a portion of said pin fins are bonded to the bottom surface of the overlying foil.

21. The system of claim 20, wherein at least a portion of said pin fins further comprise:
at least one wing disposed to a lateral side of said pin fin, wherein said wing is disposed and at least partially downstream of said pin fin.
